(19) United States
(12) Patent Application Publication
(10) Pub. No.: US 2024/0058749 A1
(43) Pub. Date: Feb. 22, 2024

(54) DEVICE AND METHOD FOR DEGRADING GASEOUS ORGANIC POLLUTANT THROUGH ELECTROCHEMICAL PROCESS

(71) Applicant: SHENZHEN PUREMATE TECHNOLOGY CO., LTD., Shenzhen (CN)

(72) Inventors: Lizhi ZHANG, Shenzhen (CN); Falong JIA, Shenzhen (CN); Yiqing YAN, Shenzhen (CN); Fangsheng YAN, Shenzhen (CN)

(73) Assignee: SHENZHEN PUREMATE TECHNOLOGY CO., LTD., Shenzhen (CN)

(21) Appl. No.: 18/261,082

(22) PCT Filed: Nov. 25, 2021
(86) PCT No.: PCT/CN2021/133036

§ 371 Date: Jul. 25, 2023

(30) Foreign Application Priority Data
Jan. 11, 2021 (CN) 202110034784.X

(51) Int. Cl. B01D 53/32; C25B 11/032; C25B 11/046; C25B 11/051; C25B 9/63; C25B 1/23

(52) U.S. Cl. CPC B01D 53/326; C25B 11/032; C25B 11/046; C25B 11/051; C25B 9/63; C25B 1/23

(57) ABSTRACT

Disclosed are a device and a method for degrading a gaseous organic pollutant through electrochemical process. The device includes an electrochemical reactor, the electrochemical reactor comprises a power supply, an anode, a cathode, a proton exchange membrane, an anode airflow channel and a cathode airflow channel, the anode is provided in the anode airflow channel, the cathode is provided in the cathode airflow channel, the proton exchange membrane is arranged between the anode and the cathode, the anode, the proton exchange membrane and the cathode are clamped, and a titanium suboxide material coating is provided on a surface of the anode.

### CROSS-REFERENCE TO RELATED APPLICATIONS

This application is the National Stage of International Application No. PCT/CN2021/133036, filed on Nov. 25, 2021, which claims priority to Chinese Patent Application No. 202110034784.X, filed on Jan. 11, 2021, the entire contents of which are incorporated herein by reference.

### TECHNICAL FIELD

The present application relates to the technical field of purifying a gaseous organic pollutant, and in particular, to a device and a method for degrading a gaseous organic pollutant through electrochemical process.

### BACKGROUND

At present, an electrochemical oxidation method is commonly used for the degradation of volatile gaseous organic pollutants. This degradation method has attracted much attention since it does not need to add any chemical reagents, is easy to operate, and is environmentally friendly. The core technology of the electrochemical oxidation method is the anode electrocatalytic material. The anode electrode materials used in the related art mainly include boron-doped diamond, lead oxide, and tin oxide. However, these electrode materials often have the following problems: boron-doped diamond has a high cost and is difficult to be widely used; it is often difficult to avoid the potential release of lead ions during the use of lead oxide electrode materials, which is easy to cause secondary environmental pollution and limit their applications; tin oxide electrode materials often have problems such as poor electrode stability and short electrode life.

### SUMMARY

The main objective of the present application is to provide a device and a method for degrading a gaseous organic pollutant through electrochemical process, aiming to solve the problems of anode electrode materials in the related art.

In order to achieve the above objective, the present application provides a device for degrading a gaseous organic pollutant through electrochemical process, including an electrochemical reactor, the electrochemical reactor includes a power supply, an anode, a cathode, a proton exchange membrane, an anode airflow channel and a cathode airflow channel, the anode is provided in the anode airflow channel, the cathode is provided in the cathode airflow channel, the proton exchange membrane is arranged between the anode and the cathode, the anode, the proton exchange membrane and the cathode are clamped, and a titanium suboxide material coating is provided on a surface of the anode.

In an embodiment, the surface of the anode is completely covered by the titanium suboxide material coating.

In an embodiment, a thickness of the titanium suboxide material coating ranges from 0.1 μm to 500 μm.

In an embodiment, the anode is a gas-permeable metal electrode, and the gas-permeable metal electrode is selected from one of a foam titanium electrode, a foam titanium alloy electrode, a titanium mesh electrode and a titanium alloy mesh electrode.

In an embodiment, the cathode is a gas-permeable electrode loaded with an oxygen reduction catalyst, and the oxygen reduction catalyst is selected from at least one of platinum, rhodium, ruthenium, palladium, nickel, cobalt oxide, iron compounds and molybdenum compounds.

In an embodiment, the loading amount of the oxygen reduction catalyst is 0.1 mg/cm² to 10.0 mg/cm².

In an embodiment, the air-permeable electrode is selected from one of a carbon paper electrode, a carbon fiber cloth electrode, a foam nickel electrode, a foam titanium electrode, a foam titanium alloy electrode, a titanium mesh electrode and a titanium alloy mesh electrode.

The present application also provides a method for degrading a gaseous organic pollutant through electrochemical process, applied to a device for degrading the gaseous organic pollutant through electrochemical process as described above, comprising:
introducing gas containing the gaseous organic pollutant into an anode airflow channel, and introducing gas or air containing the gaseous organic pollutant into a cathode airflow channel; and
applying a direct current voltage between a cathode that degrades the gaseous organic pollutant and an anode that reduces oxygen in the air.

In an embodiment, a relative humidity of the gas containing the gaseous organic pollutant is 2% to 100%; and/or, a relative humidity of the air is 2% to 100%.

In an embodiment, the direct current voltage ranges from 0.3V to 36V; and/or, the temperature during the degradation of the gaseous organic pollutant is controlled within the range of −40° C. to 70° C.

The present application adopts the device for degrading the gaseous organic pollutant through electrochemical process to degrade the gaseous organic pollutant. The surface of the anode of the electrochemical reactor is provided with a titanium suboxide material coating, the oxygen evolution overpotential of the titanium suboxide material is higher than that of boron-doped diamond and SnO₂ electrode materials. Therefore, the surface-adsorbed water molecules can be efficiently oxidized into hydroxyl radical active species, and the volatile organic compounds in the gas can be oxidized and degraded, so that the volatile organic compounds can be decomposed into carbon dioxide and water, and the efficient degradation of the gaseous organic pollutant can be achieved. At the same time, the titanium suboxide material also has good electrical conductivity and chemical stability, and the service life of the electrochemical reactor is greatly improved. Therefore, the device for degrading the gaseous organic pollutant through electrochemical process has excellent long-lasting stability and obvious advantages in terms of reliability in practical applications. In addition, the device for degrading the gaseous organic pollutant through electrochemical process of the present application is applicable to the degradation of all gaseous organic pollutants, is not limited by the water solubility of organic pollutants, and has a wide range of applications and great potential for application in the field of environmental pollution treatment.

### BRIEF DESCRIPTION OF THE DRAWINGS

In order to more clearly describe the technical solutions in the embodiments of the present application or the related art, a brief introduction will be given to the accompanying drawings required in the description of the embodiments or the related art. It is obvious that the accompanying drawings in the following description are only some embodiments of the present application, and those skilled in the art can also obtain other drawings based on the structures shown in these drawings without any creative effort.

FIG. 1 is an X-ray diffraction spectrogram of a titanium suboxide material coating on the surface of an anode in a device for degrading a gaseous organic pollutant through electrochemical process according to the present application.

FIG. 2 is a degradation efficiency of benzene under different voltages.

FIG. 3 is a ratio of CO₂ and CO after degradation of benzene under different voltages.

FIG. 4 is a graph illustrating the relationship between the relative humidity of the intake air and the degradation efficiency of benzene.

FIG. 5 is a graph illustrating the relationship between the degradation efficiency of benzene, current density and time under long-term continuous electrolysis.

The implementation, functional features and advantages of the object of the present application will be further described in conjunction with the embodiments and with reference to the accompanying drawings.

### DETAILED DESCRIPTION OF THE EMBODIMENTS

The technical solutions of the embodiments of the present application will be clearly and completely described below. It is obvious that the embodiments to be described are only some rather than all of the embodiments of the present application. All other embodiments obtained by persons skilled in the art based on the embodiments of the present application without creative efforts shall fall within the scope of the present application.

In addition, the technical solutions of the various embodiments can be combined with each other, which must be based on what those skilled in the art can implement. When the combination of technical solutions is contradictory or cannot be implemented, it should be considered that the combination of such technical solutions does not exist and is not within the scope of the present application.

The present application provides a device for degrading a gaseous organic pollutant through electrochemical process, which is configured to degrade the gaseous organic pollutant.

In an embodiment of the present application, the device for degrading the gaseous organic pollutant through electrochemical process includes an electrochemical reactor, which includes a power supply, an anode, a cathode, a proton exchange membrane, an anode airflow channel, and a cathode airflow channel. The anode is provided in the anode airflow channel, the cathode is provided in the cathode airflow channel, the proton exchange membrane is arranged between the anode and the cathode, the anode, the proton exchange membrane and the cathode are clamped, and a titanium suboxide material coating is provided on a surface of the anode.

Here, the power supply adopts a direct current (DC) power supply. The anode airflow channel is used to feed gas containing the gaseous organic pollutant, and the cathode airflow channel is used to feed air. The anode is provided in the anode airflow channel, the cathode is provided in the cathode airflow channel, the proton exchange membrane is arranged between the cathode and the anode, and the anode, the proton exchange membrane and the cathode are clamped, so that an electrochemical reactor can be obtained. Since the titanium suboxide material coating is provided on the surface of the anode, the titanium suboxide material coating can be provided on the surface of the anode by coating, spraying, dipping or other methods. The main active component of the titanium suboxide material is Ti₄O₇. Compared with boron-doped diamond and SnO₂ electrode materials, the titanium suboxide material has a higher oxygen evolution overpotential, which is conducive to the efficient oxidation of surface-adsorbed water molecules into hydroxyl radicals, so as to realize the efficient degradation of the gaseous organic pollutant. At the same time, the titanium suboxide material also has good electrical conductivity and chemical stability, and the service life of the electrochemical reactor is greatly improved, so that the device for degrading the gaseous organic pollutant through electrochemical process has excellent long-lasting stability and obvious advantages in terms of reliability in practical applications. In addition, the device for degrading the gaseous organic pollutant through electrochemical process of the present application is applicable to the degradation of all gaseous organic pollutants, and is not limited by the water solubility of organic pollutants.

In the technical solution of the present application, it can be understood that the device for degrading the gaseous organic pollutant through electrochemical process is used to degrade the gaseous organic pollutant, the titanium suboxide material coating is provided on the surface of the anode of the electrochemical reactor, and the oxygen evolution overpotential of the titanium suboxide material is higher than that of boron-doped diamond and SnO₂ electrode materials. Therefore, the surface-adsorbed water molecules can be efficiently oxidized into hydroxyl radical active species, and the volatile organic compounds in the gas can be oxidized and degraded, so that the volatile organic compounds can be decomposed into carbon dioxide and water, and the efficient degradation of the gaseous organic pollutant can be achieved. At the same time, the titanium suboxide material also has good electrical conductivity and chemical stability, and the service life of the electrochemical reactor is greatly improved, so that the device for degrading the gaseous organic pollutant through electrochemical process has excellent long-lasting stability and obvious advantages in terms of reliability in practical applications. In addition, the device for degrading the gaseous organic pollutant through electrochemical process of the present application is applicable to the degradation of all gaseous organic pollutants, is not limited by the water solubility of organic pollutants, and has a wide range of applications and great potential for application in the field of environmental pollution treatment.

It should be noted that the device for degrading the gaseous organic pollutant through electrochemical process further includes a conveying equipment and a conveying pipeline, wherein the conveying pipeline is connected with the anode airflow channel, the conveying pipeline is connected with the cathode airflow channel, and each of the conveying pipelines are provided with the conveying equipment. The conveying equipment is a fan or an air pump.

In an optional embodiment, in order to further improve the degradation rate of the gaseous organic pollutant, the surface of the anode substrate is completely covered by the titanium suboxide material coating. Therefore, when the gas containing the gaseous organic pollutant enters the anode airflow channel, since the surface of the anode substrate is completely covered by the titanium suboxide material coating, the surface-adsorbed water molecules can be efficiently oxidized into hydroxyl radical active species, and the volatile organic compounds in the gas can be oxidized and degraded, so that the volatile organic compounds can be decomposed into carbon dioxide and water, and the efficient degradation of the gaseous organic pollutant can be achieved. At the same time, the service life of the electrochemical reactor is further improved.

It should be noted that when the anode is a gas-permeable anode, that is, the anode layer has micropores, the titanium suboxide material coating covers all or part of the pore walls of the micropores. Therefore, when the gaseous organic pollutant is introduced, the contact between the gaseous organic pollutant and the titanium suboxide material coating is more thorough, which can further and more effectively degrade the gaseous organic pollutant.

When the anode is made, the thickness of the titanium suboxide material coating should be reasonably controlled to make it fully effective. In an optional embodiment, the thickness of the titanium suboxide material coating ranges from 0.1 μm to 500 μm, for example, the thickness of the titanium suboxide material coating is 0.1 μm, 0.5 μm, 2 μm, 5 μm, 10 μm, 20 μm, 30 μm, 50 μm, 100 μm, 200 μm, 300 μm, 400 μm or 500 μm. It can be understood that if the thickness of the titanium suboxide material coating is less than 0.1 μm, the effect of the titanium suboxide material is small, the surface-absorbed water molecules cannot be efficiently oxidized into hydroxyl radicals, and the degradation rate of the gaseous organic pollutant is not high; if the thickness of the titanium suboxide material coating is greater than 500 μm, some of the titanium suboxide materials cannot fully exert their functions, resulting in material waste and high cost.

In an optional embodiment, the anode is a gas-permeable metal electrode, and the gas-permeable metal electrode is selected from any one of foam titanium electrode, foam titanium alloy electrode, titanium mesh electrode, and titanium alloy mesh electrode.

Here, the gas-permeable metal electrode is used for the anode. Therefore, when the gas containing the gaseous organic pollutant is processed, the gas can pass through the anode, which can remove the gaseous organic pollutant more efficiently. When the gas-permeable metal electrode is selected, one of the foam titanium electrode, the foam titanium alloy electrode, the titanium mesh electrode and the titanium alloy mesh electrodes can be used.

In an optional embodiment, the cathode is a gas-permeable electrode loaded with an oxygen reduction catalyst, and the oxygen reduction catalyst is selected from at least one of platinum, rhodium, ruthenium, palladium, nickel, cobalt oxide, iron compounds and molybdenum compounds.

Since air enters the cathode airflow channel, the oxygen in the air undergoes a reduction reaction at the cathode. Here, the gas-permeable electrode is used for the cathode, and the air can pass through the cathode material, which is conducive to the reduction reaction of oxygen.

In an optional embodiment, the load range of the oxygen reduction catalyst is 0.1 mg/cm²-10.0 mg/cm², for example, the load range of the oxygen reduction catalyst is 0.1 mg/cm², 0.2 mg/cm², 0.3 mg/cm², 0.4 mg/cm², 0.6 mg/cm², 0.8 mg/cm², 1.0 mg/cm², 2.0 mg/cm², 3.0 mg/cm², 5.0 mg/cm² or 10.0 mg/cm².

Optionally, the gas-permeable electrode is selected from any one of carbon paper electrode, carbon fiber cloth electrode, foam nickel electrode, foam titanium electrode, foam titanium alloy electrode, titanium mesh electrode, and titanium alloy mesh electrode.

The present application also provides a method for degrading the gaseous organic pollutant through electrochemical process, applied to the aforementioned device for degrading the gaseous organic pollutant through electrochemical process. The method for degrading a gaseous organic pollutant through electrochemical process includes the following steps:
introducing the gas containing the gaseous organic pollutant into the anode airflow channel respectively, and introducing the gas or the air containing the gaseous organic pollutant into the cathode airflow channel; and
applying a DC voltage between the cathode that degrades the gaseous organic pollutant and the anode that reduces the oxygen in the air.

Here, the gas itself containing the gaseous organic pollutant contains a certain amount of gaseous water molecules. After passing through the anode airflow channel, the gaseous water molecules will be oxidized to generate hydroxyl radical active substances after adsorbed on the surface of the anode of the titanium suboxide, which in turn oxidize and degrade the volatile organic compound in the gas to decompose the volatile organic compounds into carbon dioxide and water. At the same time, air is introduced into the cathode airflow channel, and the oxygen in the air undergoes a reduction reaction on the cathode, and forms a stable electrochemical reaction loop together with the anode reaction.

In some other embodiments, the gas containing the gaseous organic pollutant can also be introduced into the cathode airflow channel. In practical operation, air and the gas containing the gaseous organic pollutant can be simultaneously introduced into the cathode airflow channel and the anode airflow channel, the gaseous organic pollutant is degraded at the anode, and the oxygen in the air is reduced at the cathode.

In the method for degrading the gaseous organic pollutant through electrochemical process of the present application, it can be understood that the oxygen evolution overpotential of the titanium suboxide material is higher than that of boron-doped diamond and SnO₂ electrode materials. Therefore, the surface-adsorbed water molecules can be efficiently oxidized into hydroxyl radical active species, and the volatile organic compounds in the gas can be oxidized and degraded, so that the volatile organic compounds can be decomposed into carbon dioxide and water, and the efficient degradation of the gaseous organic pollutant can be achieved. At the same time, the titanium suboxide material also has good electrical conductivity and chemical stability, and the service life of the electrochemical reactor is greatly improved. Therefore, the device for degrading the gaseous organic pollutant through electrochemical process has excellent long-lasting stability and obvious advantages in terms of reliability in practical applications. In addition, the device for degrading the gaseous organic pollutant through electrochemical process of the present application is applicable to the degradation of all gaseous organic pollutants, is not limited by the water solubility of organic pollutants, and has a wide range of applications.

The relative humidity of the gas containing the gaseous organic pollutant will affect the degradation efficiency of the gaseous organic pollutant, so the relative humidity needs to be controlled. Optionally, the relative humidity of the gas containing the gaseous organic pollutant should be controlled within the range of 2%-100%, for example, the relative humidity of the gas containing the gaseous organic pollutant is 2%, 5%, 10%, 20%, 40%, 50%, 60%, 80% or 100%. Controlling the relative humidity of the gas containing the gaseous organic pollutant within the above range can ensure a high degradation rate of the gaseous organic pollutant. Preferably, the relative humidity of the gas containing the gaseous organic pollutant is 40%-90%.

At the same time, the relative humidity of the air should be controlled at 2%-100%, for example, the relative humidity of the air is 2%, 10%, 20%, 40%, 50%, 60%, 80% or 100%. In this way, it is possible to improve the degradation rate of the gaseous organic pollutant more effectively. Preferably, the relative humidity of the air is controlled at 40%-90%.

In an optional embodiment, the range of the DC voltage is 0.3V-36V. During the operation of the electrochemical reactor, a DC voltage of 0.3V-36V is applied between the cathode and the anode to enable the electrochemical method to effectively degrade the gaseous organic pollutant. Preferably, a DC voltage of 3V-12V is applied between the cathode and the anode.

In the process of degrading the gaseous organic pollutant through electrochemical process, it is necessary to reasonably control the temperature during the degradation process, and control the degradation temperature within the range of −40° C. to 70° C., so as to improve the degradation efficiency of the gaseous organic pollutant. Preferably, the degradation temperature is controlled within the range of 5° C. to 40° C.

Optionally, the gaseous organic pollutant is the volatile gaseous organic pollutant, may be benzene, toluene, xylene, formaldehyde or other VOC gases, and have a wide range of applications.

The device and the method for degrading the gaseous organic pollutant through electrochemical process of the present application will be described in detail below through specific embodiments.

### Embodiment 1

(1) Preparation of the anode: A foam titanium sheet with a filtration precision of 50 μm is used as a substrate to load titanium suboxide. First, the foam titanium is put into acetone for ultrasonic degreasing and water-washing, and is immersed in 10 wt % oxalic acid solution at 90° C. for 2 hours to remove the oxide layer on the titanium surface, at the same time, the titanium surface is formed with a roughness of about 5 μm; subsequently, the treated foam titanium sheet is fixed on the metal baffle, and the titanium suboxide is sprayed on the foam titanium by plasma spraying method, the spraying power is 30 KW, and the spraying thickness is controlled at about 20 μm by adjusting the spraying amount. The sprayed foam titanium is washed with ethanol and dried to obtain foam titanium loaded by titanium suboxide, which is used as the anode for subsequent gas-solid phase electrochemistry.

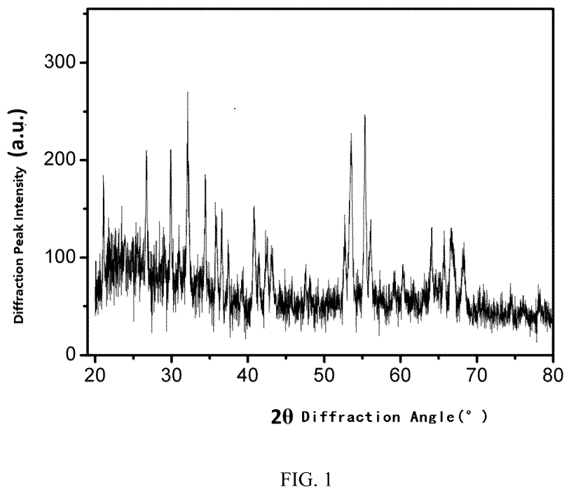

The X-ray diffraction spectrum test was carried out on the surface coating of the anode. The test results are shown in FIG. 1. The position of the diffraction peak is basically consistent with the spectrum of the standard Ti₄O₇ sample, indicating that the surface of the foam titanium has been uniformly covered by titanium suboxide with Ti₄O₇ structure.

(2) Preparation of the cathode: with foam nickel as the cathode carrier, the cathode can be obtained by electrolytic degreasing and water-washing, soaking in 0.2M hydrochloric acid solution for 5 minutes to remove the oxide layer, soaking in 0.01M chloroplatinic acid solution for 5 minutes, water-washing and drying with dry nitrogen.

(3) Assembly of the electrochemical reactor: a proton exchange membrane is placed between the anode prepared in step (1) and the cathode prepared in step (2), and hot pressing at 80° C. and 6 MPa for 2 minutes is performed to obtain a membrane electrode group. Subsequently, the membrane electrode group is sandwiched between the anode airflow channel and the cathode airflow channel, and the anode and the cathode are respectively connected to the positive and negative electrodes of the DC power supply through wires, so the electrochemical reactor can be obtained.

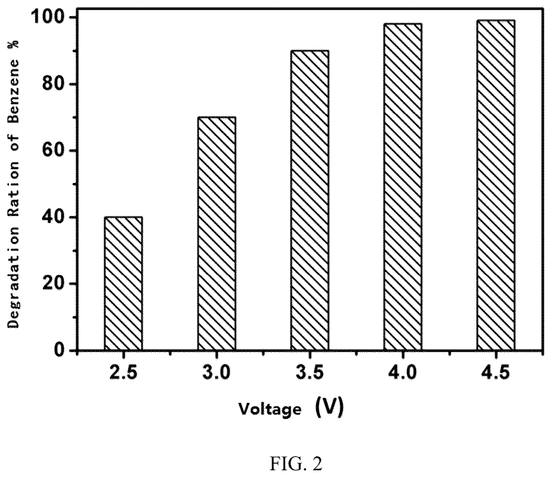

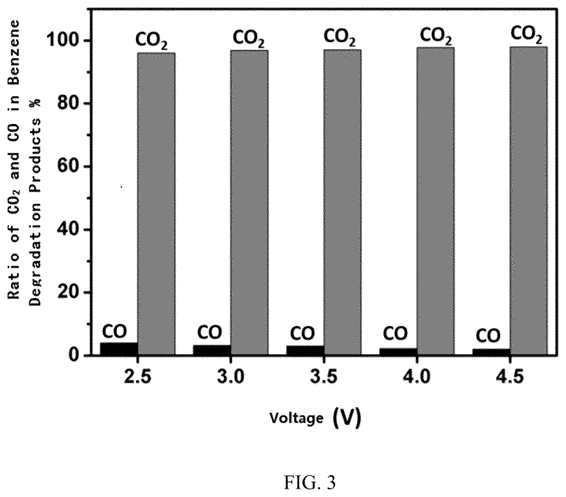

(4) The electrochemical reactor in step (3) is used to degrade the gaseous organic pollutant: introducing the gas containing the typical volatile organic pollutant-“benzene” (with a relative humidity of 60%) into the anode airflow channel, with a benzene concentration of 10 ppm and a gas flow rate of 20 mL/min; while introducing air (with a relative humidity of 60%) into the cathode airflow channel, with a flow rate of 20 mL/min. Subsequently, applying different DC voltages between the anode and the cathode, and monitoring the concentration of benzene pollutants and the amount of CO₂ generated at the outlet of the anode airflow channel during stability. The catalytic performance is shown in FIG. 2 and FIG. 3. From FIG. 2 and FIG. 3, it can be seen that when the voltage is increased to 4V, most of benzene (>97%) is degraded and removed, and the degradation product is mainly CO₂ (95%), indicating that the gas-solid phase electrochemical based on titanium suboxide anode can efficiently mineralize benzene.

### Embodiment 2: Influence of Intake Relative Humidity on Degradation Efficiency of Gaseous Organic Pollutants

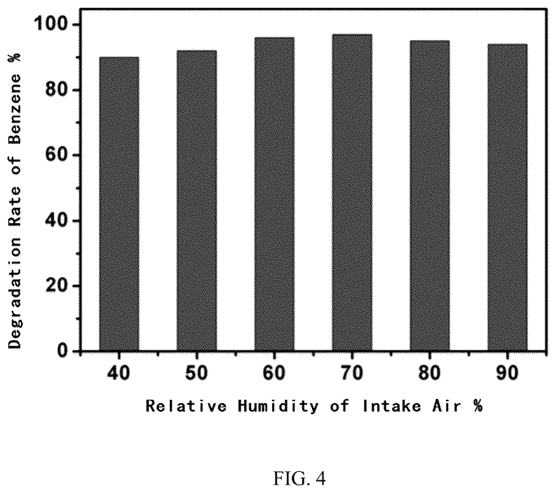

The anode, cathode and assembled electrochemical reaction device in Example 1 are used to control the relative humidity of the intake air in the anode area from 40% to 90%, the concentration of benzene in the intake air is 10 ppm, and the gas flow rate is 20 mL/min. At the same time, the relative humidity of the air entering the cathode area is controlled to be consistent with that of the air entering the anode area, and the air flow rate is 20 mL/min. After continuous gas flow on both sides for 4 hours, each component in the electrochemical reactor has reached an equilibrium state of water vapor adsorption, and then a 4V voltage is applied between the anode and the cathode to detect the degradation rate of benzene under stable flow electrolysis. The results are shown in FIG. 4, the degradation rate of benzene exceeds 90% at different relative humidity, especially in the relative humidity of 60% to 80%, the degradation rate of benzene remains above 95%.

### Embodiment 3: Stability Test for Degrading the Gaseous Organic Pollutant Through Electrochemical Process

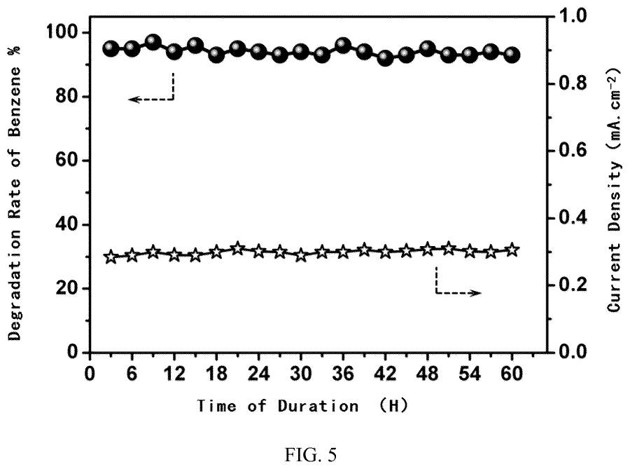

The anode, cathode and assembled electrochemical reaction device in Example 1 are used to introduce the gas containing the typical volatile organic pollutant-“benzene” (with a relative humidity of 60%) into the anode airflow channel, with a benzene concentration of 10 ppm and a gas flow rate of 20 mL/min; while introduce air (with a relative humidity of 60%) into the cathode airflow channel, with a flow rate of 20 mL/min. Subsequently, applying a voltage of 4V between the anode and the cathode, and monitoring the concentration of benzene pollutants and current at the outlet of the anode airflow channel during stability. The relationship between benzene degradation efficiency, current density and time under long-term continuous electrolysis is shown in FIG. 5. From FIG. 5, it can be seen that during the continuous degradation process for 60 hours, the degradation rate of benzene remains about 94%, and the current density remains basically stable at about 0.3 mA·cm⁻². This indicates that titanium suboxide electrode can still maintain stable electrical conductivity and electrocatalytic performance under long-term anodic polarization, and also reflects the excellent stability of the surface structure of the electrode material.

### Embodiment 4

Foam titanium with a filtration accuracy of 30 μm is soaked in acetone to degrease and water-washing, then soaked in 10 wt % oxalic acid solution at 80° C. for 3 hours, water-washing and drying. Next, titanium suboxide powder (particle size of 1 μm to 5 μm) and polyethylene glycol are ball milled according to a mass ratio of 1:5, then the ground slurry is evenly coated on the surface of foam titanium, put into a heat treatment furnace, and calcined it for 3 hours at 1000° C. in hydrogen atmosphere to obtain a foam titanium anode loaded by titanium suboxide. At the same time, with carbon paper as the electrode carrier, the surface is sprayed with platinum/carbon particle catalyst, and the catalyst load is 0.8 mg/cm², which is used as the cathode. A proton exchange membrane is placed between the anode and cathode prepared above, and a membrane-electrode group is obtained by hot-pressing at 90° C. and 5 MPa for 2 minutes. Subsequently, the membrane electrode group is sandwiched between the anode airflow channel and the cathode airflow channel, and the anode and the cathode are respectively connected to the positive and negative electrodes of the DC power supply through wires, so the electrochemical reactor can be obtained. Next, the gas containing the typical volatile organic pollutant-“benzene” (with a relative humidity of 60%) is introduced into the anode airflow channel, with a benzene concentration of 10 ppm and a gas flow rate of 20 mL/min; while air (with a relative humidity of 70%) is introduced into the cathode airflow channel, with a flow rate of 20 mL/min. Subsequently, a voltage of 4.5V is applied between the anode and the cathode and the content of benzene in the gas is continuously detected, the results shows that 90% of benzene was degraded and removed.

The above descriptions are only some embodiments of the present application, and are not intended to limit the scope of the present application. Under the inventive concept of the present application, any equivalent structural transformations made by using the contents of the description of the present application, or directly/indirectly applications in other related technical fields, are included in the scope of the present application.

1. A device for degrading a gaseous organic pollutant through electrochemical process, comprising:
an electrochemical reactor comprising a power supply, an anode, a cathode, a proton exchange membrane, an anode airflow channel and a cathode airflow channel,
wherein the anode is provided in the anode airflow channel, the cathode is provided in the cathode airflow channel, the proton exchange membrane is arranged between the anode and the cathode, the anode, the proton exchange membrane and the cathode are clamped, and a titanium suboxide material coating is provided on a surface of the anode.

2. The device for degrading the gaseous organic pollutant through electrochemical process according to claim 1, wherein the surface of the anode is completely covered by the titanium suboxide material coating.

3. The device for degrading the gaseous organic pollutant through electrochemical process according to claim 1, wherein a thickness of the titanium suboxide material coating ranges from 0.1 μm to 500 μm.

4. The device for degrading the gaseous organic pollutant through electrochemical process according to claim 1, wherein the anode is a gas-permeable metal electrode, and the gas-permeable metal electrode is selected from one of a foam titanium electrode, a foam titanium alloy electrode, a titanium mesh electrode and a titanium alloy mesh electrode.

5. The device for degrading the gaseous organic pollutant through electrochemical process according to claim 1, wherein the cathode is a gas-permeable electrode loaded with an oxygen reduction catalyst, and the oxygen reduction catalyst is selected from at least one of platinum, rhodium, ruthenium, palladium, nickel, cobalt oxide, iron compounds and molybdenum compounds.

6. The device for degrading the gaseous organic pollutant through electrochemical process according to claim 5, wherein a loading amount of the oxygen reduction catalyst is 0.1 mg/cm² to 10.0 mg/cm².

7. The device for degrading the gaseous organic pollutant through electrochemical process according to claim 5, wherein the air-permeable electrode is selected from one of a carbon paper electrode, a carbon fiber cloth electrode, a foam nickel electrode, a foam titanium electrode, a foam titanium alloy electrode, a titanium mesh electrode and a titanium alloy mesh electrode.

8. A method for degrading a gaseous organic pollutant through electrochemical process, applied to the device for degrading the gaseous organic pollutant through electrochemical process according to claim 1, comprising:
introducing gas containing the gaseous organic pollutant into an anode airflow channel, and introducing gas or air containing the gaseous organic pollutant into a cathode airflow channel; and
applying a direct current voltage between a cathode that degrades the gaseous organic pollutant and an anode that reduces oxygen in the air.

9. The method for degrading the gaseous organic pollutant through electrochemical process according to claim 8, wherein a relative humidity of the gas containing the gaseous organic pollutant is 2% to 100%; and/or
a relative humidity of the air is 2% to 100%.

10. The method for degrading the gaseous organic pollutant through electrochemical process according to claim 8, wherein:
the direct current voltage ranges from 0.3V to 36V; and/or
a temperature during a degradation of the gaseous organic pollutant is controlled within a range of −40° C. to 70° C.
